(19) United States
(12) Patent Application Publication
(10) Pub. No.: US 2015/0079217 A1
(43) Pub. Date: Mar. 19, 2015

(54) Device for Printing Simultaneously Three Dimensional Objects

(71) Applicant: SDD Holding B.V., Emst (NL)

(72) Inventor: Johannes Franciscus Roland Oudsen, Epe (NL)

(21) Appl. No.: 14/488,773

(22) Filed: Sep. 17, 2014

(30) Foreign Application Priority Data
Sep. 19, 2013 (EP) 13185223.8

(51) Int. Cl. B29C 67/00

(52) U.S. Cl. CPC B29C 67/0059; B29C 67/0085
USPC 425/375

(57) ABSTRACT

A device for printing simultaneously three dimensional objects includes a support surface for supporting the object to be printed and a carriage arranged over the support surface. The carriage is movable along two axes of a Cartesian coordinate system parallel to the support surface the distance between the carriage and the support surface is adjustable. A number of printing heads are arranged at the carriage. The printing heads are positioned at a regular first pitch distance along the first axis of the Cartesian coordinate system and at a regular second pitch distance along the second axis of the Cartesian coordinate system.

### CROSS-REFERENCE TO RELATED APPLICATION

This application claims priority to European Patent Application No. 13185223.8 filed Sep. 19, 2013, the disclosure of which is hereby incorporated in its entirety by reference.

### BACKGROUND OF THE INVENTION

1. Field of the Invention

The invention relates to a device for printing simultaneously three dimensional objects, which device includes a support surface for supporting the object to be printed; and a carriage arranged over the support surface, which carriage is movable along two axes of a Cartesian coordinate system parallel to the support surface, wherein the distance between the carriage and the support surface is adjustable.

2. Description of Related Art

Devices for printing three dimensional objects are already known for a few decades. The basic principal of all these devices is the same. Layers of a certain material are stacked on top of each other in order to obtain a three dimensional object.

A first method of three dimensional printing is arranging a layer of a curable fluid or granular material on a support surface and heating this layer with a laser beam, such that a two dimensional layer is created of cured fluid or melted granular material. The support surface is then lowered by the thickness of the layer and a new layer of curable fluid or granular material is provided and again irradiated by the laser. By repeating these steps a three dimensional object can be achieved built out of a plurality of layers.

A second method of three dimensional printing is by directing an extrusion nozzle over a support surface to build a layer of material out of extruded material, typically an extruded plastic. Again, after finishing a layer, the support layer is lowered by the thickness of the finished layer and a new layer is extruded on top of the finished layer. This method also results in a three dimensional object after repeating the steps numerous times.

The operational costs of three dimensional printing have dropped dramatically in the last years and the quality of the printed objects has increased, such that three dimensional printing has become a viable manufacturing alternative for low volume products, like special parts for all kind of devices.

A disadvantage of the known printers is the lack of speed for producing a three dimensional object. Because an object is built out of layers of curable material or meltable material, it takes time for the material of a layer to solidify. Furthermore, to obtain an object with a high accuracy, one needs to print layers of a small thickness. But then a larger number of layers is needed to obtain a single object.

So, the speed of the three dimensional printing is inversely proportional to the desired accuracy and furthermore dependent on the speed with which material can be solidified. This will provide a problem when a small number of identical products are desired as the production time will increase proportional to the amount of desired products.

Another problem of known three dimensional printing devices is the relative small dimensions of the objects to be printed. Of course it is possible to scale a known device, but production time will also increase, because the printing time of a single layer will increase with the power of two. This is due to the single printing head having to cover a larger surface and having to deposit a larger volume of material. Combined with the increased number of layers necessary for a larger object, this will quickly result in unpractical production times.

Accordingly it is an object of the invention to provide a device for printing simultaneously three dimensional objects.

### SUMMARY OF THE INVENTION

This object is achieved according to the invention with a device according to the preamble, which device is characterized by a number of printing heads arranged at the carriage, wherein the printing heads are positioned at a regular first pitch distance along the first axis of the Cartesian coordinate system and at a regular second pitch distance along the second axis of the Cartesian coordinate system.

The device according to the invention has a number of printing heads on the carriage, such that all printing heads will move synchronous. When all printing heads are also activated synchronous, identical objects will be formed. Because all printing heads will generate simultaneously a three dimensional object, the production time of the same number of objects as the number of printing heads, will be the same as the production time of a single object.

The device according to the invention can also be used for reducing the production time of large objects. Each printing head covers a part of the support surface and the printing heads combined can cover the full support surface. So, by cleverly moving the carriage and selectively activating the printing heads, one can generate layers for a large object quicker, than by moving a single printing head over the full support surface.

The movements of the carriage and the adjusting of the distance between the carriage and the support surface should be interpreted as movements relative to the support surface. It would for example also be possible to have a stationary carriage with the printing heads and a support surface, which is movable in the direction of all three axes of the Cartesian coordinate system.

The printing heads are preferably arranged in at least two rows, but for some applications, like long elongate objects it could be advantageous to use a single row printing heads. In such a case, the second pitch distance would be zero.

In a preferred embodiment of the device according to the invention the stroke of the carriage in the direction of the first axis is less than two times, preferably substantially equal to, the first pitch distance and wherein the stroke of the carriage in the direction of the second axis is less than two times, preferably substantially equal to, the second pitch distance.

Only when a single row of printing heads is used, the stroke in the direction of the second axis would not be equal to zero, but would be equal to the full width of the support surface.

When the printing heads are equally distributed over the area of the support surface, the carriage only has to move over a small distance in both directions for the combined printing heads to cover the full support surface. In some cases it could be of advantage when the movement of the printing heads have a certain overlap, such that the objects made by two or more adjacent printing heads could be fused together.

In this way it is possible to make in one run the same number of objects as the number of printing heads, or a smaller number of objects, which have dimensions larger than could be made by a single printing head.

The stroke in both directions is dependent on the number of printing heads in the respective direction. If the number of printing heads in a direction is decreased, the stroke will be increased and vice versa.

In another embodiment of the device according to the invention, the device further comprises a frame arranged around the support surface, a carriage beam extending in the direction of the second axis arranged to the frame and movable in the direction of the first axis and a guide rail arranged on the carriage beam for guiding the carriage in the direction of the second axis.

This embodiment provides a simple, reliable and cost effective way of moving the carriage.

In yet another embodiment of the device according to the invention the frame is movable in the direction of the third axis of the Cartesian coordinate system in order to adjust the distance between the carriage and the support surface.

In a further preferred embodiment of the device according to the invention each printing head comprises a first extrusion nozzle for selectively extruding a first plastic.

The three dimensional printing technique using an extrusion nozzle is also called fused deposition modeling and is in particular suitable for small volume products.

Preferably each printing head comprises a second extrusion nozzle for selectively extruding a second plastic.

The second plastic can be used for providing a support structure for the first plastic. This enables the production of virtually any shape. The second plastic could for example be soluble in water or has a lower melting point than the first plastic, such that the support structure can easily be removed after printing the three dimensional object by either submerging the object in water or by heating the object to the melting temperature of the second plastic.

Depending on the printing method used, it could be desired to have a heated environment. For example, when extrusion is used, it is desired to ensure that the ambient temperature is high, e.g. 100° C., such that the extruded plastic is not cooled suddenly. To this end, the support surface may be heated. The support surface could be a sheet of glass which is provided at the bottom with heating elements. By arranging a housing around the device, the heat from the glass will be contained, to ensure a high ambient temperature. Also the housing provides a protection for the operator of the device against the moving parts and the high temperature.

### BRIEF DESCRIPTION OF THE DRAWINGS

These and other features of the invention will be elucidated in conjunction with the accompanying drawings.

FIG. 1 shows a perspective view of an embodiment of a device according to the invention.

FIG. 2 shows a schematic top view of the device according to FIG. 1.

FIG. 3 shows a schematic top view of the support surface with a first configuration of printed objects.

FIG. 4 shows a schematic top view of the support surface with a second configuration of printed objects.

### DESCRIPTION OF THE INVENTION

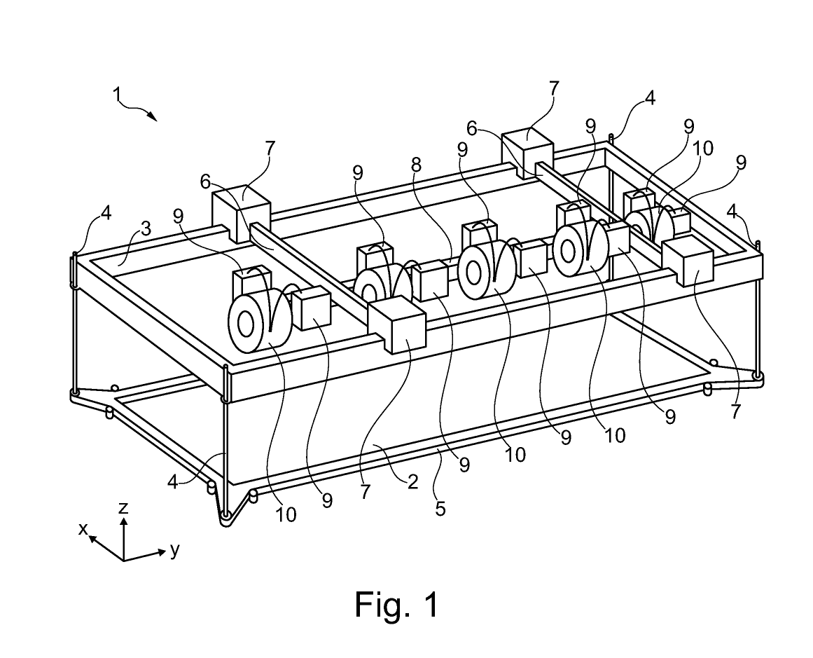

FIG. 1 shows a perspective view of an embodiment of a device 1 according to the invention. The device 1 has a support surface 2 on which the objects are printed. A frame 3 is arranged around the support surface 2. This frame 3 is height adjustable in a Z-direction with the screw spindles 4, which are simultaneously driven by a drive belt 5.

Two carriage beams 6 are supported on the frame 3 by bearings 7, such that both carriage beams 6 can be displaced in the Y-direction.

The carriage beams 6 support the carriage 8, which is provided with a number of printing heads 9 and supply reals for supplying a plastic to the printing heads 9. The carriage 8 is guided by the carriage beams 6, such that the carriage 8 is movable in the X-direction.

The movement of the frame 3, the carriage beams 6 and the carriage 8 are typically controlled by a controller or computer, which also controls the printing heads 9 in order to arrive at the desired shape of the three dimensional object.

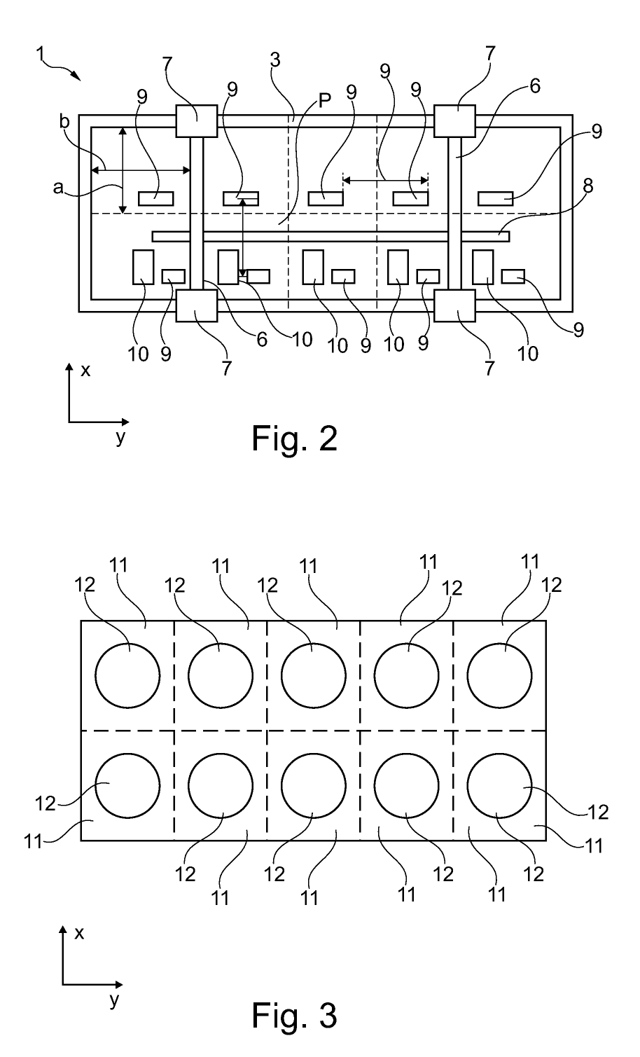

FIG. 2 shows a schematic top view of the device 1 according to FIG. 1. The shown embodiment 1 has ten printing heads 9 attached to the carriage 8. Each printing head 9 covers a part of the support surface 2, which is indicated by the ten areas 11 bordered by the dotted lines. (see also FIG. 3)

The stroke a of the carriage 8 in the X-direction needs only to be equal to the pitch distance p between the two rows of printing heads 9 to cover the full width of the support surface 2. Similarly, the stroke b of the carriage in the Y-direction needs only to be equal to the pitch distance q of the printing heads 9 in a row.

It could be of advantage to have a somewhat larger stroke in both directions, such that some overlap is present of the working areas of the printing heads 9.

As shown in FIG. 3 it is possible with the device 1 according to the invention to simultaneously print ten three dimensional objects 12, wherein each printing head is responsible for printing a single object.

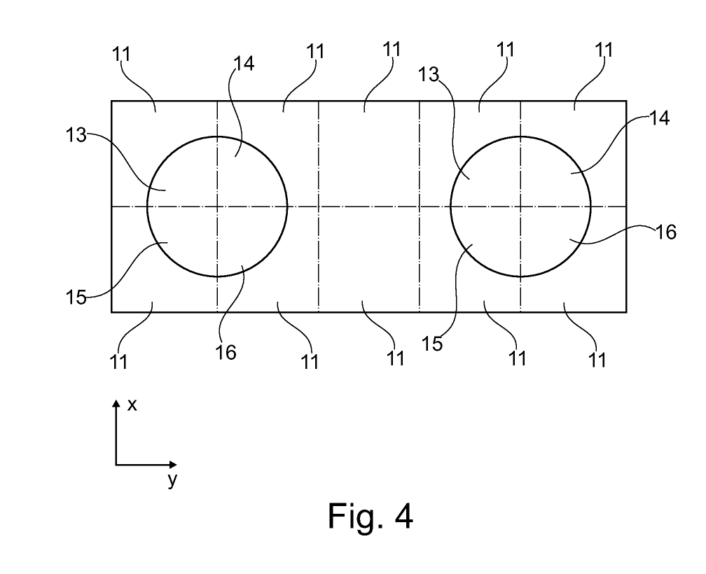

As shown in FIG. 4 it would also be possible with the device of FIG. 1 to print a second configuration of three dimensional objects 13, 14, 15, 16. The three dimensional objects 13, 14, 15 16 are in this configuration fused together such that two large objects are created, which could otherwise not be printed with a single printing head 9 or would take a substantial amount of time to print in comparison of printing simultaneously with four printing heads 9 per large object.

Although the invention is elucidated with printing heads being supplied with a plastic and accordingly use the fused deposition modeling method, it is obvious that the arrangement of multiple printing heads on a carriage can also be used for the three dimensional printing methods using a curable fluid or a granular material.

1. A device for printing simultaneously three dimensional objects, which device comprises:
a support surface for supporting the object to be printed; and
a carriage arranged over the support surface, which carriage is movable along two axes of a Cartesian coordinate system parallel to the support surface, wherein the distance between the carriage and the support surface is adjustable; wherein
a number of printing heads are arranged at the carriage, and wherein the printing heads are positioned at a regular first pitch distance along the first axis of the Cartesian coordinate system and at a regular second pitch distance along the second axis of the Cartesian coordinate system.

2. The device according to claim 1, wherein the stroke of the carriage in the direction of the first axis is less than two times, preferably substantially equal to, the first pitch distance, and wherein the stroke of the carriage in the direction of the second axis is less than two times, preferably substantially equal to, the second pitch distance.

3. The device according to claim 1, further comprising a frame arranged around the support surface, a carriage beam extending in the direction of the second axis arranged to the frame and movable in the direction of the first axis, and a guide rail arranged on the carriage beam for guiding the carriage in the direction of the second axis.

4. The device according to claim 3, wherein the frame is movable in the direction of a third axis of the Cartesian coordinate system in order to adjust the distance between the carriage and the support surface.

5. The device according to claim 1, wherein each printing head comprises a first extrusion nozzle for selectively extruding a first plastic.

6. The device according to claim 5, wherein each printing head comprises a second extrusion nozzle for selectively extruding a second plastic.

7. The device according to claim 2, further comprising a frame arranged around the support surface, a carriage beam extending in the direction of the second axis arranged to the frame and movable in the direction of the first axis, and a guide rail arranged on the carriage beam for guiding the carriage in the direction of the second axis.

8. The device according to claim 7, wherein the frame is movable in the direction of a third axis of the Cartesian coordinate system in order to adjust the distance between the carriage and the support surface.

9. The device according to claim 2, wherein each printing head comprises a first extrusion nozzle for selectively extruding a first plastic.

10. The device according to claim 3, wherein each printing head comprises a first extrusion nozzle for selectively extruding a first plastic.

11. The device according to claim 4, wherein each printing head comprises a first extrusion nozzle for selectively extruding a first plastic.

12. The device according to claim 7, wherein each printing head comprises a first extrusion nozzle for selectively extruding a first plastic.

13. The device according to claim 8, wherein each printing head comprises a first extrusion nozzle for selectively extruding a first plastic.

14. The device according to claim 9, wherein each printing head comprises a second extrusion nozzle for selectively extruding a second plastic.

15. The device according to claim 10, wherein each printing head comprises a second extrusion nozzle for selectively extruding a second plastic.

16. The device according to claim 11, wherein each printing head comprises a second extrusion nozzle for selectively extruding a second plastic.

17. The device according to claim 12, wherein each printing head comprises a second extrusion nozzle for selectively extruding a second plastic.

18. The device according to claim 13, wherein each printing head comprises a second extrusion nozzle for selectively extruding a second plastic.
